(19) United States
(12) Patent Application Publication
(10) Pub. No.: US 2011/0046909 A1
(43) Pub. Date: Feb. 24, 2011

(54) SYSTEM AND METHOD FOR CALCULATING OBSERVATIONAL ERRORS OF A COORDINATE MEASURING MACHINE

(75) Inventors: CHIH-KUANG CHANG, Tu-Cheng (TW); ZHONG-KUI YUAN, Shenzhen City (CN); XIAO-GUANG XUE, Shenzhen City (CN); JIANG-HONG ZHANG, Shenzhen City (CN); XIAN-YI CHEN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/815,410

(22) Filed: Jun. 15, 2010

(30) Foreign Application Priority Data
Aug. 21, 2009 (CN) 200910305889.3

(51) Int. Cl. G06F 19/00; G01B 5/008

(52) U.S. Cl. 702/95

(57) ABSTRACT

A system and method for calculating an observational error of a coordinate measuring machine includes receiving measuring parameters input by a user, obtaining observational errors of the ruler from a storage system, and identifying the zero mark of the ruler. A direction of the ruler is adjusted to be substantially parallel to the measuring direction of the measuring parameters, controlling the coordinate measuring machine to measure the ruler according to the measuring parameters, obtaining measured data. Observational error of the coordinate measuring machine is calculated according to the measured data, which is stored in the storage system.

### BACKGROUND

1. Field of the Disclosure

Embodiments of the present disclosure relate to error calculation system and method, and particularly to a system and method for calculating an observational error of a coordinate measuring machine.

2. Description of Related Art

A coordinate measuring machine (CMM) is widely used in the manufacturing industry to measure products. Measurement data acquired from the CMM is more accurate than other measuring machines; however, the CMM may have errors, such as an observational error, for example. The observational error is the difference between a measured value of quantity and its true value. Therefore, it is necessary to determine the observational error and compensate for the observational error of the CMM to obtain more accurate data.

### BRIEF DESCRIPTION OF THE DRAWINGS

FIG. 1 is a block diagram of one embodiment of a computing system for calculating an observational error of a coordinate measuring machine.

FIG. 2 is a block diagram of one embodiment of the observational error calculation system in the FIG. 1.

FIG. 3 is a flowchart of one embodiment of a method for calculating an observational error of a coordinate measuring machine.

### DETAILED DESCRIPTION

All of the processes described below may be embodied in, and fully automated via, functional code modules executed by one or more general purpose computers or processors. The code modules may be stored in any type of computer-readable medium or other computer storage system device. Some or all of the methods may alternatively be embodied in specialized computer hardware.

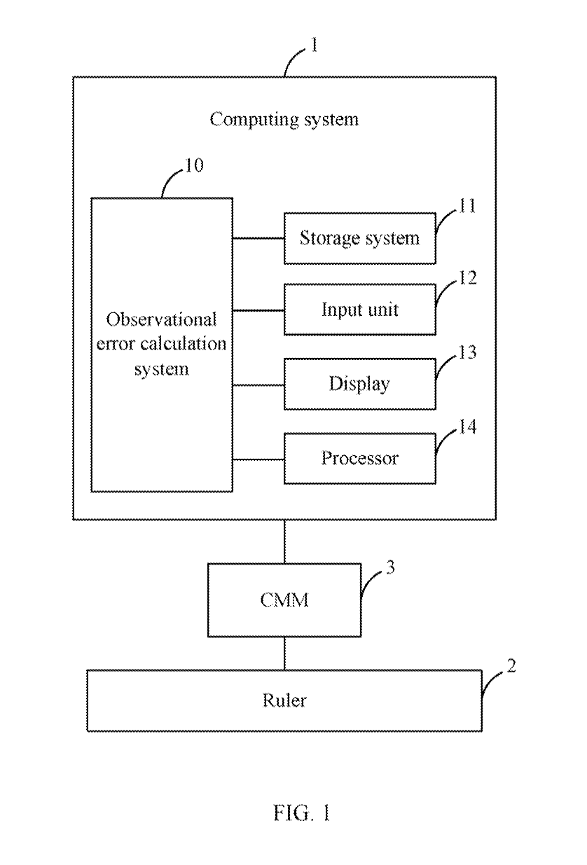

FIG. 1 is a block diagram of one embodiment of a computing system 1 for calculating an observational error calculation of a coordinate measuring machine (CMM) 3. The CMM 3 may be used to measure a ruler 2 to obtain measured data of the ruler 2.

The computing system 1 includes a observational error calculation system 10, a storage system 11, an input unit 12, a display 13, and a processor 14. The storage system 11 may be a hard disk, random access memory, read only memory, a cache system, or a combination of the aforementioned hardware. The storage system 11 may store various kinds of data, such as the observational errors of the ruler 2, for example. The input unit 12 is used to input measuring parameters, such as measuring directions, measuring lengths, and measuring items. In one embodiment, the display 13 may display a report including the observational error of the CMM 3 on a display of the computing system 1 or on an external display. The processor 14 executes one or more computerized operations of the computing system 1 and other applications, to provide functions of the computing system 1.

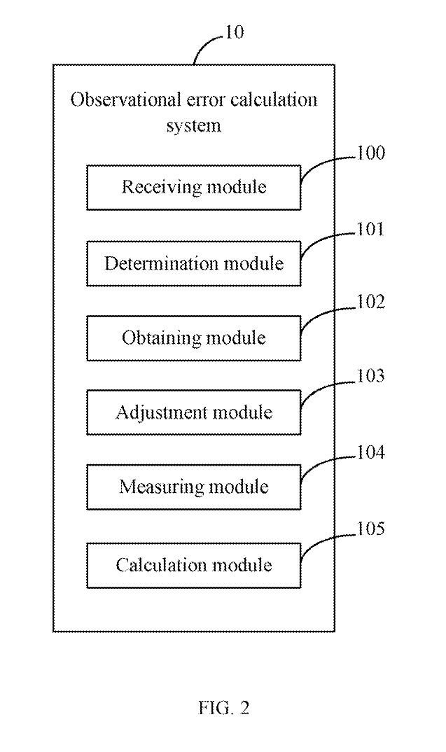

FIG. 2 is a block diagram of one embodiment of the observational error calculation system 10 in the FIG. 1. In one embodiment, the observational error calculation system 10 includes a receiving module 100, a determination module 101, an obtaining module 102, an adjustment module 103, a measuring module 104, and a calculation module 105. The modules 100, 101, 102, 103, 104, and 105 may comprise one or more computerized codes to be executed by the processor 14 to perform one or more operations of the computing system 1.

The receiving module 100 receives a user login request input by a user to access the observational error calculation system 10.

The determination module 101 determines whether the received user login request is valid. If the received user login request is the same as a preset user login request in the storage system 11, the determination module 101 determines that the received user login request is valid. Otherwise, if the received user login request is not the same as the preset user login request in the storage system 11, the determination module 101 determines that the received user login request is invalid.

The receiving module 100 receives measuring parameters input by the user, the measuring parameters include a measuring direction, measuring lengths, measuring items, and a type of a ruler 2. In one embodiment, the measuring direction may include, but is not limited to, an X-axis direction, a Y-axis direction, a direction having a 45° angle with respect to the X-axis, and a direction having a 135° angle with respect to the X-axis. The measuring items include how many times to measure the ruler 2, how long to measure each measuring length, and a length of the ruler 2. In one embodiment, if the maximum measuring length of the CMM 3 is 300 mm, the length of the ruler 2 is 260 mm, the measuring length may be 30 mm, 60 mm, 120 mm, 180 mm, and 240 mm.

The obtaining module 102 obtains observational errors of a plurality of measuring lengths of the ruler 2 from the storage system 11, and identifies the zero mark of the ruler 2. For example, an observational error of 30 mm of the ruler 2 is +0.002 mm, an observational error of 60 mm of the ruler 2 is −0.0018 mm, an observational error of 120 mm of the ruler 2 is +0.0012 mm.

The adjustment module 103 adjusts a direction of the ruler 2 to be substantially parallel to the measuring direction of the measuring parameters.

The measuring module 104 controls the CMM 1 to measure the ruler 2 according to the plurality of measuring lengths and measuring items, and obtains the measured data.

The calculation module 105 calculates the observational error of each of the plurality of measuring lengths of the CMM 3 according to the observational error and the measured data corresponding to each of the plurality of measuring lengths, and stores the observational errors in the storage system 11. For example, if a measuring length is 30 mm, a observational error at 30 mm of the ruler 2 is +0.002 mm, and a measured data measured by the CMM 3 at 30 mm is 30.0012 mm. Thus, an observational error of the CMM 3 is 30 mm+0.002 mm−30.0012 mm=0.0008 mm.

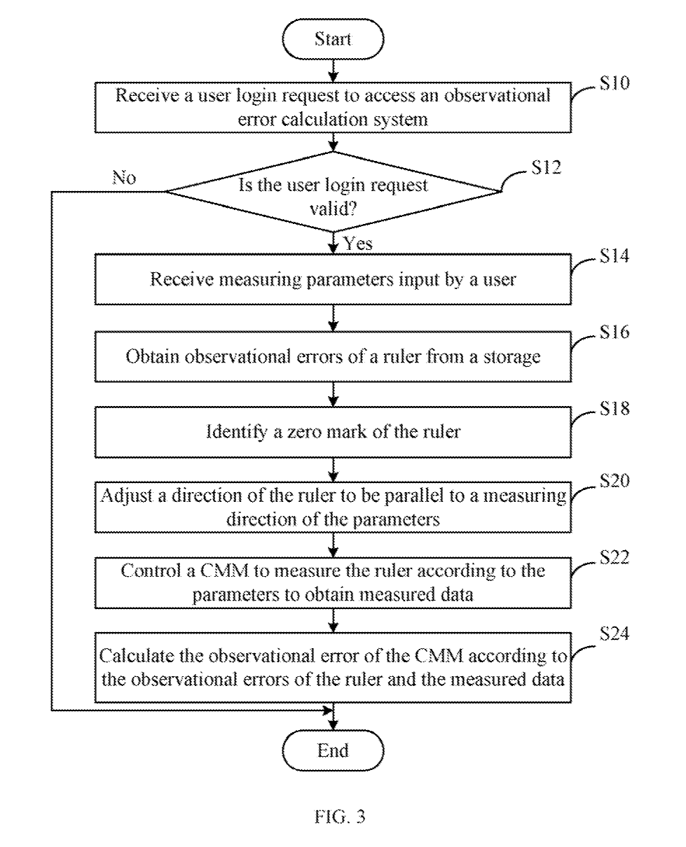

FIG. 3 is a flowchart of one embodiment of a method for calculating an observational error of a CMM. The method of the flowchart of FIG. 3 can be used to calculate observational errors of a plurality of measuring lengths of the CMM. Depending on the embodiment, additional blocks may be added, others deleted, or the order of the blocks may be changed.

In block S10, the receiving module 100 receives a user login request input by a user to access the observational error calculation system 10.

In block S12, the determination module 101 determines whether the received user login request is valid. If the received user login request is the same as a preset user login request in the storage system 11, the determination module 101 determines that the received user login request is valid. Otherwise, if the received user login request is not the same as a preset user login request in the storage system 11, the determination module 101 determines that the received user login request is invalid.

In block S14, the receiving module 100 receives measuring parameters input by the user, the measuring parameters includes a measuring direction, measuring lengths, measuring items, and a type of a ruler 2.

In block S16, the obtaining module 102 obtains the observational errors of a plurality of measuring lengths of the ruler 2 from the storage system 11. For example, an observational error at 30 mm of the ruler 2 is +0.002 mm, a observational error at 60 mm of the ruler 2 is −0.0018 mm, an observational error at 120 mm of the ruler 2 is +0.0012 mm.

In block S18, the obtaining module 102 identifies the zero mark of the ruler 2.

In block S20, the adjustment module 103 adjusts a direction of the ruler 2 to be substantially parallel to the measuring direction of the measuring parameters.

In block S22, the measuring module 104 controls the CMM 3 to measure the ruler 2 according to the plurality of measuring lengths and measuring items, and obtain measured data.

In block S24, the calculation module 105 calculates an observational error of each of the plurality of measuring lengths of the CMM 3 according to the observational error and measured data corresponding to each of the plurality of measuring lengths, and stores the observational errors in the storage system 11. For example, if a measuring length is 30 mm, a observational error at 30 mm of the ruler 2 to be measure is +0.002 mm, and a measured data measured by the CMM 3 at 30 mm is 30.0012 mm. Thus, an observational error of the CMM 3 is =30 mm+0.002 mm−30.0012 mm=0.0008 mm.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for calculating an observational error of a coordinate measuring machine, the computing system comprising:
a storage system operable to store observational errors of a ruler;
at least one processor; and
one or more programs stored in the storage system and being executable by the at least one processor, the one or more programs comprising:
a receiving module operable to receive measuring parameters input by a user, the measuring parameters comprising a measuring direction, measuring lengths, and measuring items;
an obtaining module operable to obtain the observational errors of a plurality of measuring lengths of the ruler from the storage system, and identify a zero mark of the ruler;
an adjustment module operable to adjust a direction of the ruler to be substantially parallel to the measuring direction of the measuring parameters;
a measure module operable to control the coordinate measuring machine to measure the ruler according to the plurality of measuring lengths and measuring items, and obtain measured data; and
a calculation module operable to calculate the observational error of each of the plurality of measuring lengths of the coordinate measuring machine according to the observational error and the measured data, and store the observational errors in the storage system.

2. The computing system of claim 1, wherein the receiving module is further operable to receive a user login request, and determine whether the user login request is valid.

3. The computing system of claim 1, wherein the measuring directions comprises an X-axis direction, a Y-axis direction, a direction having a 45° angle with respect to the X-axis, and a direction having a 135° angle with respect to the X-axis.

4. The computing system of claim 1, wherein the measuring items comprises how many times to measure the ruler, how long to measure each of the plurality of measuring lengths, and a length of the ruler.

5. A computer-implemented method for calculating an observational error of a coordinate measuring machine, the method implemented by a computerized device, and the method comprising:
receiving measuring parameters input by a user, the measuring parameters comprising a measuring direction, measuring lengths, and measuring items;
obtaining observational errors of a plurality of measuring lengths of the ruler from a storage system of the computerized device, and identifying a zero mark of the ruler;
adjusting a direction of the ruler to be substantially parallel to the measuring direction of the measuring parameters;
controlling the coordinate measuring machine to measure the ruler according to the plurality of measuring lengths and measuring items, and obtaining measured data;
calculating the observational error of each of the plurality of measuring lengths of the coordinate measuring machine according to the observational error and the measured data, and storing the observational errors in the storage system.

6. The method of claim 5, further comprising:
receiving a user login request;
determining whether the user login request is valid.

7. The method of claim 5, wherein the measuring directions comprises an X-axis direction, a Y-axis direction, a direction having a 45° angle with respect to the X-axis, and a direction having a 135° angle with respect to the X-axis.

8. The method of claim 5, wherein the measuring items comprises how many times to measure the ruler, how long to measure each of the plurality of measuring lengths, and a length of the ruler.

9. A computer-readable medium having stored thereon instructions that, when executed by a computerized device, causes the computerized device to execute a method for calculating an observational error of a coordinate measuring machine, the method comprising:
receiving measuring parameters input by a user, the measuring parameters comprising a measuring direction, measuring lengths, and measuring items;
obtaining observational errors of a plurality of measuring lengths of the ruler from a storage system of the computerized device, and identifying a zero mark of the ruler;
adjusting a direction of the ruler to be substantially parallel to the measuring direction of the measuring parameters;
controlling the coordinate measuring machine to measure the ruler according to the plurality of measuring lengths and measuring items, and obtaining measured data;
calculating the observational error of each of the plurality of measuring lengths of the coordinate measuring machine according to the observational error and the measured data, and storing the observational errors in the storage system.

10. The medium of claim 9, wherein the method further comprises:
receiving a user login request;
determining whether the user login request is valid.

11. The medium of claim 9, wherein the measuring directions comprises an X-axis direction, a Y-axis direction, a direction having a 45° angle with respect to the X-axis, and a direction having a 135° angle with respect to the X-axis.

12. The medium of claim 11, wherein the measuring items comprises how many times to measure the ruler, how long to measure each of the plurality of measuring lengths, and a length of the ruler.
